(19) United States
(12) Patent Application Publication
(10) Pub. No.: US 2025/0184847 A1
(43) Pub. Date: Jun. 5, 2025

(54) METHOD, DEVICE AND SYSTEM OF MOBILE MANAGEMENT FOR COMPUTING POWER

(71) Applicant: ZTE CORPORATION, Shenzhen (CN)

(72) Inventors: Baoguo XIE, Shenzhen (CN); Jinguo ZHU, Shenzhen (CN); Weibin WANG, Shenzhen (CN)

(73) Assignee: ZTE CORPORATION, Shenzhen (CN)

(21) Appl. No.: 19/034,731

(22) Filed: Jan. 23, 2025

Related U.S. Application Data
(63) Continuation of application No. PCT/CN2022/136314, filed on Dec. 2, 2022.

(51) Int. Cl. H04W 36/16; H04W 36/36; H04W 52/40

(52) U.S. Cl. CPC H04W 36/165; H04W 36/36; H04W 52/40

(57) ABSTRACT

A wireless communication method for use in a computing power controlling node is disclosed. The method comprises acquiring computing power resource information of at least one computing power consuming node, and selecting a target computing power consuming node from the at least one target computing power consuming node candidate based on the computing power resource information of the at least one target computing power consuming node candidate and computing power requirement information of a wireless device, for a handover associated with computing power resources for the wireless device.

### CROSS-REFERENCE TO RELATED APPLICATION

This application claims the benefit of priority under 35 U.S.C. § 120 as a continuation of International Patent Application No. PCT/CN2022/136314, filed on Dec. 2, 2022, the disclosure of which is incorporated herein by reference in its entirety.

### TECHNICAL FIELD

This document is directed generally to wireless communications, and in particular to wireless communications associated with mobile management for computing power.

### BACKGROUND

In recent years, the computing network convergence is underdeveloped, wherein relevant key solutions for the computing network convergence include computing power routing, unique ID identity, computing measurement, computing power dispatching, and so on. The computing power network (CPN) may be involved in the existing networks (e.g., 4G/5G network), to provide computing services for applications performed on user equipment (UE). When the UE and/or a computing server providing the computing resources for the UE moves, the UE may need to be handed over to another computing server. Therefore, the handover of the UE from one (source) computing server to another (target) computing server is required to be discussed.

### SUMMARY

This document relates to methods and devices for mobile management for computing power and in particular to methods and devices for a handover of the computing server providing the computing power.

The present disclosure relates to a wireless communication method for use in a computing power controlling node. The method comprises acquiring computing power resource information of at least one computing power consuming node, and selecting a target computing power consuming node from the at least one target computing power consuming node candidate based on the computing power resource information of the at least one target computing power consuming node candidate and computing power requirement information of a wireless device, for a handover associated with computing power resources for the wireless device.

Various embodiments may preferably implement the following features:

Preferably or in some embodiments, the at least one target computing power consuming node candidate serves an area in which the wireless device locates.

Preferably or in some embodiments, the wireless communication method further comprises transmitting, to a wireless network node serving the wireless device, information of the target computing power consuming node.

Preferably or in some embodiments, the wireless communication method further comprises receiving, from the wireless network node, a handover notification of the handover.

Preferably or in some embodiments, the handover notification comprises at least one of the computing power requirement information or location information of the wireless device.

Preferably or in some embodiments, the wireless network node comprises at least one of a base station, an access and mobility management function or a session management function.

Preferably or in some embodiments, the wireless communication method further comprises handing over a computing power consuming node serving the wireless device from a source computing power consuming node to the target computing power consuming node.

Preferably or in some embodiments, the wireless communication method further comprises determining the handover of the wireless device.

Preferably or in some embodiments, the wireless communication method further comprises receiving a handover request associated with the handover of the wireless device.

Preferably or in some embodiments, the computing power controlling node comprises at least one of a base station serving the wireless device, an access and mobility management function serving the wireless device or a session management function serving the wireless terminal.

Preferably or in some embodiments, the computing power consuming node comprises at least one of a base station, a user plane function, or a computing power node which has computing power resources or is associated with at least one computing power server.

The present disclosure relates to a wireless communication method for use in a wireless network node. The method comprises:
transmitting, to a computing power controlling node, a handover notification of a handover associated with computing power resources for a wireless device, and
receiving, from the computing power controlling node, a target computing power consuming node for the handover.

Various embodiments may preferably implement the following features:

Preferably or in some embodiments, the wireless communication method further comprises handing over a computing power consuming node serving the wireless device from a source computing power consuming node to the target computing power consuming node.

Preferably or in some embodiments, the handover notification comprises at least one of computing power requirement information or location information of the wireless device.

Preferably or in some embodiments, the wireless network node comprises at least one of a base station, an access and mobility management function or a session management function serving the wireless device.

Preferably or in some embodiments, the target computing power consuming node comprises at least one of a base station, a user plane function or a computing power node which has computing power resources or is associated with at least one computing power server.

The present disclosure relates to a wireless communication method for use in a computing power controlling node. The method comprises:
receiving, from a source computing power server, state information of the source computing power server, and
acquiring state information of at least one computing power server serving an area of a computing power consuming node served by the source computing power server,
selecting, based on the state information of the source computing power server and the state information of the at least one computing power server, a target computing power server from the at least one computing power servers, and
transmitting, to the computing power consuming node served by the source computing power server, information of the target computing power server in a handover notification.

Various embodiments may preferably implement the following features:

Preferably or in some embodiments, the state information comprises at least one of location information or computing power resource information.

Preferably or in some embodiments, the computing power information comprises at least one of used computing power resource information or remaining computing power resource information.

Preferably or in some embodiments, the computing power consuming node comprises at least one of a base station, a user plane function or a computing power node which has computing power resources or is associated with at least one computing power server.

The present disclosure relates to a wireless communication method for use in a computing power server. The method comprises transmitting, to a computing power controlling node, state information of the computing power server in response to a change in a location of the computing power server.

Various embodiments may preferably implement the following features:

Preferably or in some embodiments, the state information comprises at least one of location information or computing power resource information.

Preferably or in some embodiments, the computing power information comprises at least one of used computing power resource information or remaining computing power resource information.

The present disclosure relates to a computing power controlling node. The computing power controlling node comprises:
a processor, configured to:
acquire computing power resource information of at least one computing power consuming node, and
select a target computing power consuming node from the at least one target computing power consuming node candidate based on the computing power resource information of the at least one target computing power consuming node candidate and computing power requirement information of a wireless device, for a handover associated with computing power resources for the wireless device.

Various embodiments may preferably implement the following feature:

Preferably or in some embodiments, the processor is further configured to perform any of the aforementioned wireless communication methods.

The present disclosure relates to a wireless network node. The wireless network node comprises:
a communication unit, configured to:
transmit, to a computing power controlling node, a handover notification of a handover associated with computing power resources for a wireless device, and
receive, from the computing power controlling node, a target computing power consuming node for the handover.

Various embodiments may preferably implement the following feature:

Preferably or in some embodiments, the wireless network node further comprises a processor configured to perform any of the aforementioned wireless communication methods.

The present disclosure relates to a computing power controlling node. The computing power controlling node comprises:
a communication unit, configured to receive, from a source computing power server, state information of the source computing power server,
a processor, configured to acquire state information of at least one computing power server serving an area of a computing power consuming node served by the source computing power server, and select, based on the state information of the source computing power server and the state information of the at least one computing power server, a target computing power server from the at least one computing power servers,
wherein the communication unit is further configured to transmit, to the computing power consuming node served by the source computing power server, information of the target computing power server in a handover notification.

Various embodiments may preferably implement the following feature:

Preferably or in some embodiments, the processor is further configured to perform any of the aforementioned wireless communication methods.

The present disclosure relates to a computing power server. The computing power server comprises:
a communication unit, configured to transmit, to a computing power controlling node, state information of the computing power server in response to a change in a location of the computing power server.

Various embodiments may preferably implement the following feature:

Preferably or in some embodiments, the computing power server further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a schematic diagram of a functional architecture of the CPN according to an embodiment of the present disclosure.

FIG. 2 shows a schematic diagram of a network according to an embodiment of the present disclosure.

FIG. 3 shows a schematic diagram of a handover procedure according to an embodiment of the present disclosure.

FIG. 4 shows a schematic diagram of a network according to an embodiment of the present disclosure.

FIG. 5 shows a schematic diagram of a procedure according to an embodiment of the present disclosure.

FIG. 6 shows a schematic diagram of a procedure according to an embodiment of the present disclosure.

FIG. 7 shows a schematic diagram of a network according to an embodiment of the present disclosure.

FIG. 8 shows a schematic diagram of a procedure according to an embodiment of the present disclosure.

FIG. 9 shows a schematic diagram of a procedure according to an embodiment of the present disclosure.

FIG. 10 shows a schematic diagram of a procedure according to an embodiment of the present disclosure.

FIG. 11 shows a schematic diagram of a procedure according to an embodiment of the present disclosure.

FIG. 12 shows a schematic diagram of a procedure according to an embodiment of the present disclosure.

FIG. 13 shows a schematic diagram of a procedure according to an embodiment of the present disclosure.

FIG. 14 shows a schematic diagram of a procedure according to an embodiment of the present disclosure.

FIG. 15 shows an example of a schematic diagram of a wireless terminal according to an embodiment of the present disclosure.

FIG. 16 shows an example of a schematic diagram of a wireless network node according to an embodiment of the present disclosure.

### DETAILED DESCRIPTION

In the present disclosure, the term “info” refers to information.

The CPN is a type of network that realizes an optimized resource allocation by distributing computing, storage, network and other resource information of service nodes through a network control plane (such as a centralized controller, distributed routing protocol, etc.). The CPN combines network context and user requirements to provide optimal distribution, association, transaction and scheduling of computing, storage and network resources.

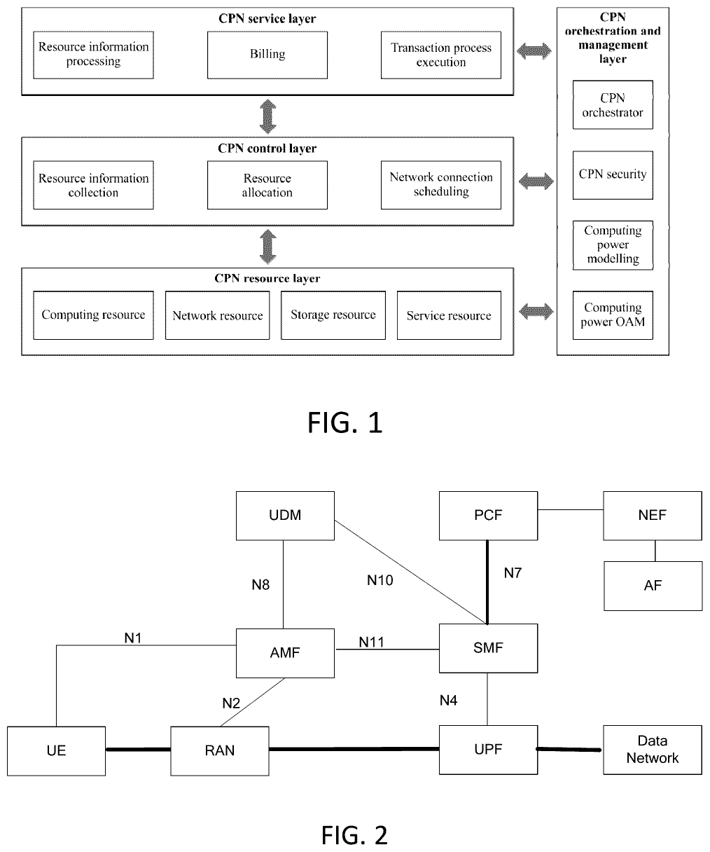

FIG. 1 shows a schematic diagram of a functional architecture of the CPN according to an embodiment of the present disclosure. The CPN shown in FIG. 1 comprises four layers which provide the aforementioned functionalities by interacting with each other.

In an embodiment, the CPN resource layer is where the computing resources reside, wherein the computing resources are provided by, e.g., computing power network providers and network operators.

The CPN control layer (realized by the CPN control plane) collects information from the CPN resource layer and sends the collected information to a CPN service layer for further processing. After receiving the processing results from the CPN service layer, the CPN control layer will pre-occupy the resources and establish a network connection.

The CPN orchestration and management layer can realize orchestration, security, modelling, and operation administration and maintenance (OAM) functions for the CPN.

The CPN service layer can realize the functions of the CPN transaction platform. The CPN service layer supports the following functionalities: Resource information processing, billing, Transaction process execution.

FIG. 2 shows a schematic diagram of a network (architecture) according to an embodiment of the present disclosure. In FIG. 1, the network comprises the following network functions/entities:

### 1) UE: User Equipment

### 2) RAN: Radio Access Network

In the present disclosure, the RAN may be equal to RAN node or next-generation RAN (NG-RAN) (node).

### 3) AMF: Access and Mobility Management Function

The AMF includes the following functionalities: Registration Management, Connection Management, Reachability Management and Mobility Management. The AMF terminates the RAN Control Plane (CP) interface N2 and NAS interface N1, non-access stratum (NAS) ciphering and integrity protection. It also distributes the session management (SM) NAS to proper session management functions (SMFs) via interface N11. The AMF provides services for other consumer Network Functions (NFs) to subscribe or get notified of the mobility related events and information.

### 4) SMF: Session Management Function

The SMF includes the following functionalities: session establishment, modification and release, UE IP address allocation & management (including optional authorization functions), selection and control of User Plane (UP) function, downlink data notification. The SMF can subscribe the mobility related events and information from AMF.

### 5) UPF: User Plane Function

The UPF includes the following functionalities: serving as an anchor point for intra-/inter-radio access technology (RAT) mobility and the external session point of interconnect to Data Network, packet routing & forwarding as indicated by SMF, traffic usage reporting, quality of service (QoS) handling for the UP, downlink packet buffering and downlink data notification triggering, etc.

### 6) UDM: Unified Data Management

The UDM manages the subscription profile for the UEs. The subscription includes the data used for mobility management (e.g., restricted area), session management (e.g., QoS profile per slice per DNN). The subscription data also includes the slice selection parameters which is used for AMF to select a proper SMF. The AMF and SMF get the subscription from UDM. The subscription data is stored in the Unified Data Repository (UDR). The UDM uses such data upon reception of request from AMF or SMF.

### 7) PCF: Policy Control Function

The PCF supports unified policy framework to govern network behavior. The PCF provides access management policy to the AMF, or session management policy to the SMF, and/or UE policy to the UE. The PCF can access the UDR to obtain subscription information relevant for policy decisions. The PCF may also generate the policy to govern network behavior based on the subscription and indication from an application function (AF). Then, the PCF can provide policy rules to CP functions (e.g., the AMF and/or the SMF) to enforce the CP functions.

### 8) NEF: Network Exposure Function

The NEF supports exposure of capability and events of the network towards the AF. A third party AF can invoke the service provided by the network via the NEF and the NEF performs authentication and authorization of the third party applications. The NEF also provides translation of the information exchanged with the AF and information exchanged with the internal NF.

### 9) AF: Application Function

The AF interacts with the Core Network in order to provide services, e.g., to support: application influence on traffic routing, accessing the NEF, interacting with the Policy framework for policy control, . . . , etc. The AF may be considered to be trusted by the operator can be allowed to interact directly with relevant NFs. The AF not allowed by the operator to access directly the NFs shall use the external exposure framework via the NEF to interact with relevant NFs. The AF may store the application information in the UDR via the NEF.

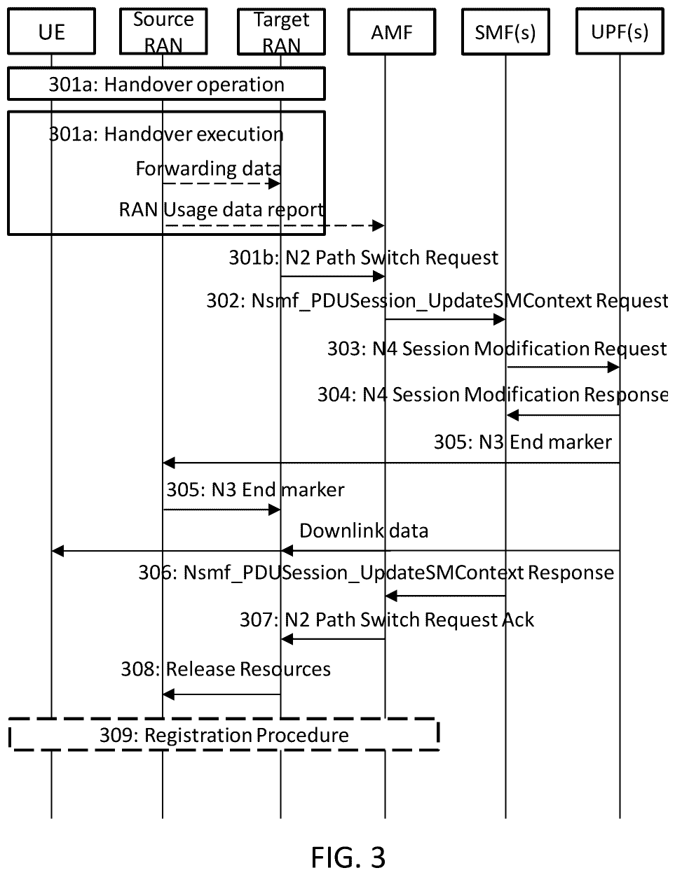

FIG. 3 shows a schematic diagram of a procedure for Xn based inter RAN handover according to an embodiment of the present disclosure. The procedure shown in FIG. 3 is used to hand over a UE from a source RAN to a target RAN via using Xn (interface) when the AMF is unchanged and the SMF decides to keep the existing UPF. In an embodiment, the source/target RAN may be a NG-RAN (next-generation RAN).

Step 301a: The source RAN requests a handover operation to the target RAN and provides the UE Radio Capability ID of the UE to the target RAN.

Step 301b: Target RAN to AMF: N2 Path Switch Request.

The Target RAN sends an N2 Path Switch Request message to an AMF, to inform that the UE has moved to a new target cell and provide a List Of PDU Sessions To Be Switched.

Step 302: AMF to SMF: Nsmf_PDUSession_UpdateSMContext Request

In a case that the AMF determines that the PDU Session is related to a LADN (local area data network), the AMF provides an indication “UE presence in LADN service area” to the SMF. If the AMF does not provide the indication “UE presence in LADN service area” and the SMF determines that the DNN corresponds to a LADN, the SMF considers that the UE is out of the LADN service area. The SMF takes actions for the LADN PDU Session as defined in based on the “UE presence in LADN service area” indication.

Step 303: SMF to UPF: N4 Session Modification Request (AN Tunnel Info)

The SMF sends an N4 Session Modification Request message to the UPF. The SMF may notify the UPF that originated the Data Notification to discard downlink data for the PDU Sessions and/or to not provide further Data Notification messages.

Step 304: UPF to SMF: N4 Session Modification Response (CN Tunnel Info)

For the PDU Sessions that are switched, the UPF returns an N4 Session Modification Response message to the SMF after requested PDU Sessions are switched.

Step 305: To assist the reordering function in the Target RAN, the UPF sends one or more “end marker” packets for each N3 tunnel on the old path immediately after switching the path. The UPF starts sending downlink packets to the Target RAN.

Step 306: SMF to AMF: Nsmf_PDUSession_UpdateSMContext Response (N2 SM information)

In step 306, the SMF sends an Nsmf_PDUSession_UpdateSMContext response (N2 SM Information (e.g., CN Tunnel Info, updated QoS parameters for the accepted QoS Flows)) to the AMF for PDU Sessions which have been switched successfully.

Step 307: AMF to RAN: N2 Path Switch Request Ack

Once receiving the Nsmf_PDUSession_UpdateSMContext response from all the SMFs, the AMF aggregates received CN Tunnel Info and sends this aggregated information as a part of N2 SM Information along with the Failed PDU Sessions in N2 Path Switch Request Ack to the Target RAN.

Step 308: By sending a Release Resources message to the Source RAN, the Target RAN confirms success of the handover. The Target RAN then triggers the release of resources with the Source RAN.

Step 309 (Optional): The UE may initiate Mobility Registration Update procedure if one of the triggers of registration procedure applies.

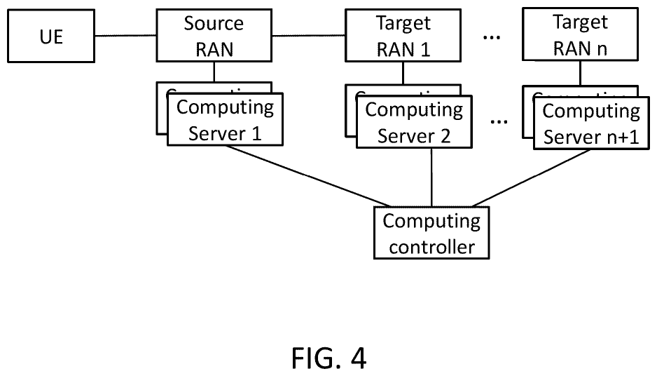

FIG. 4 shows a schematic diagram of a network according to an embodiment of the present disclosure. In FIG. 4, each source/target RAN (e.g., eNodeB for 4G and/or RAN for 5G) is served by one or more computing servers. Specifically, the source RAN is served by one or more computing servers 1, the target RAN-1 is served by one or more computing servers 2, and so on.

In FIG. 4, the network comprises an integrated computing controller configured to manage the whole computing power resources. When the source RAN receives a handover request from the UE and/or determines that the UE needs a handover, the source RAN informs the computing controller that an operation of the handover from the computing server 1 is requested, wherein the request message associated with the handover may carry place/location information of the UE. For example, the place/location information may comprise a physical geographical location, serving cell information, . . . , etc.

In an embodiment, the computing controller may acquire information relevant to computing power resources from all the target RANs in an area in which the UE is located. The computing controller then compares the acquired information with the computing power resources required by the UE and selects a suitable target RAN from those target RANs which have sufficient computing power resources for satisfying the computing power resources required by the UE.

The computing controller informs/transmits the information of the selected target RAN to the source RAN and the source RAN accordingly requests handover operation to the selected target RAN. The follow-up handover procedure may refer to the procedure shown in FIG. 3.

In some embodiments, the network may not comprise the integrated computing controller configured to manage the whole computing power resources. In these embodiments, the source RAN directly acquires relevant information of computing power resources from all the target RANs in the area in which the UE is located. The source RAN compares the acquired information with the required computing power resources for the UE and determines/gets/selects a suitable target RAN from those target RANs which have more computing power resources than needed. The source RAN requests a handover operation to the selected target RAN, wherein the request message carries the target RAN information in message. The follow-up handover procedure may refer to the procedure shown in FIG. 3.

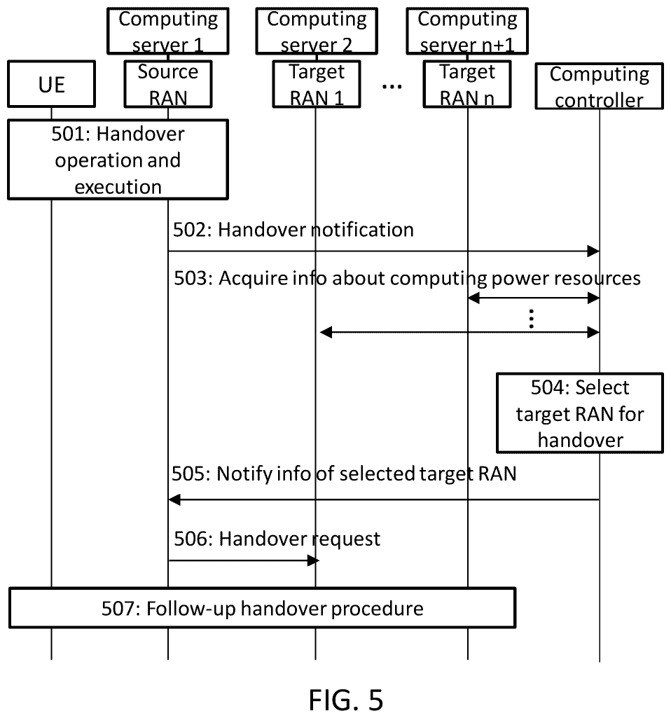

FIG. 5 shows a schematic diagram of a procedure according to an embodiment of the present disclosure. In FIG. 5, the computing controller chooses a suitable target RAN for the handover operation.

Step 501: The UE moves from the area of the source RAN to the area of the target RAN, and the UE interacts with the source RAN for handover preparation and execution.

Step 502: The source RAN received the handover request from the UE, then the source RAN send handover notification to the computing controller to request the information of target RAN which need to meet the computing power resources requirements of the UEs, the message includes the required computing power resources and the location (information) of the UE, such as physical geographical location or served cell information.

Step 503: The computing controller acquires the computing power resources of target servers from all the target RANs serving the area where the UE is located. The target RAN can get the information of computing power resources of target servers from associated served computing servers (i.e., computing server 1 to computing server n+1).

Step 504: The computing controller selects a suitable target RAN from those target RANs having available computing power resources which meet the needs/requirement of the UE.

Step 505: The computing controller notifies the source RAN the information of the selected target RAN.

Step 506: The source RAN initiates the handover request to the selected target RAN. In this embodiment, the selected target RAN is the target RAN 1.

Step 507: The follow-up handover procedure from the source RAN to the target RAN may refer to the procedure in FIG. 3.

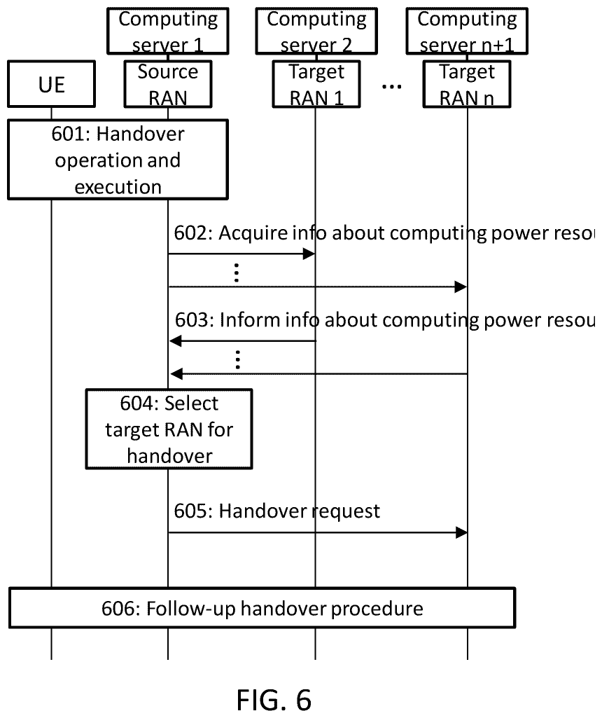

FIG. 6 shows a schematic diagram of a procedure according to an embodiment of the present disclosure. In FIG. 6, the source RAN chooses a suitable target RAN for the handover operation.

Step 601: The UE moves from the area of the source RAN to the area served by one or more target RANs and interacts with the source RAN for the handover preparation and execution.

Step 602: The source RAN acquires information associated with the computing power resources of target computing servers from all the target RANs serving the area where the UE is located. Each target RAN may get the information of computing power resources of the target computing servers from associated served computing servers, e.g., the computing server 2 to the computing server n+1.

Step 603: The target RANs inform the source RAN their available computing power resources for the handover operation.

Step 604: The source RAN select a suitable target RAN from those target RANs whose available computing power resources meet the needs/requirements of the UE.

Step 605: The source RAN initiates the handover request to the selected target RAN.

In this embodiment, the selected target RAN is the target RAN n.

Step 606: The follow-up handover procedure from the source RAN to the target RAN may refer to the procedure in FIG. 3.

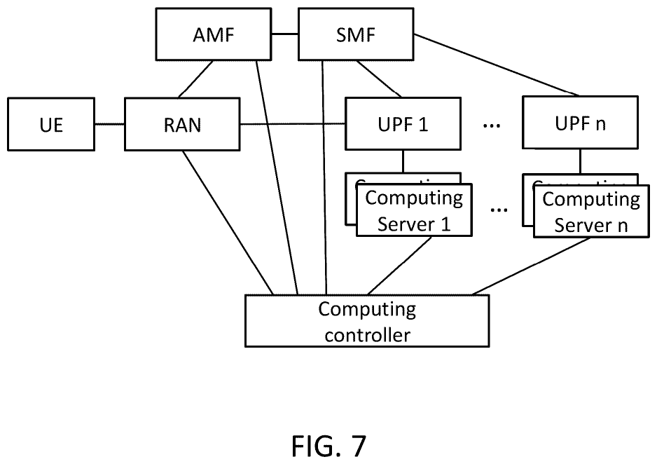

FIG. 7 shows a schematic diagram of a network according to an embodiment of the present disclosure. In FIG. 7, each of UPF 1 to UPF n is served by one or more computing servers. Specifically, the UPF 1 is served by computing server(s) 1, the UPF 2 is served by computing server(s) 2, and so on.

In some embodiments, the UE in FIG. 7 may need to move from the source Core network system (e.g., anchored in the source UPF 1 served by the computing server(s) 1) to a target Core network system (e.g., anchored in the target UPF 2 served by the computing server 2). When the UE initiates the handover request, the most suitable target UPF may be chosen to offer the computing power resources for the UE.

In FIG. 7, the network comprises the integrated computing controller configured to manage the whole computing power resources. Under such conditions, the AMF or the SMF informs the computing controller that the operation of PDU modification from [the source UPF and corresponding computing server] to [the target UPF and corresponding computing server] is requested, via transmitting a request message carrying with the location of the UE, such as physical geographical location, serving cell information, . . . , etc.

The computing controller requests to acquire information of relevant computing power resources from all the target UPFs in this area where the UE is located, compares the acquired information with the required computing power resources for the UE, and accordingly selects a suitable target UPF from those target UPFs which have more computing power resources than the required computing power resources.

In an embodiment, the computing controller informs/transmits the information of the selected target UPFs to the AMF and the AMF requests a PDN session update operation to the SMF. The SMF performs the PDU modification operation interacting with the source UPF and target UPF. The follow-up PDU session modification procedure refers to existing 3GPP handover procedure.

In an embodiment, the computing controller informs/transmits the information of selected target UPFs to the SMF. The SMF directly performs the follow-up PDU session modification procedure (e.g., at least part of procedure shown in FIG. 3).

In some embodiments, the network does not comprise the integrated computing controller configured to manage the whole computing power resources, the AMF or the SMF directly acquires relevant information of computing power resources from all of the target UPFs serving the area where the UE is located. The AMF or the SMF compares the acquired information with the computing power resources required by the UE and determines/selects a suitable target UPF from those target UPFs which have more computing power resources than those required by the UE. The AMF requests the PDN session update operation to the SMF in case that the AMF selects a target UPF, wherein the request message carries with the target UPF information. The SMF performs the PDU modification operation via interacting with source UPF and target UPF. The follow-up PDU session modification procedure refers to the handover procedure shown in FIG. 3.

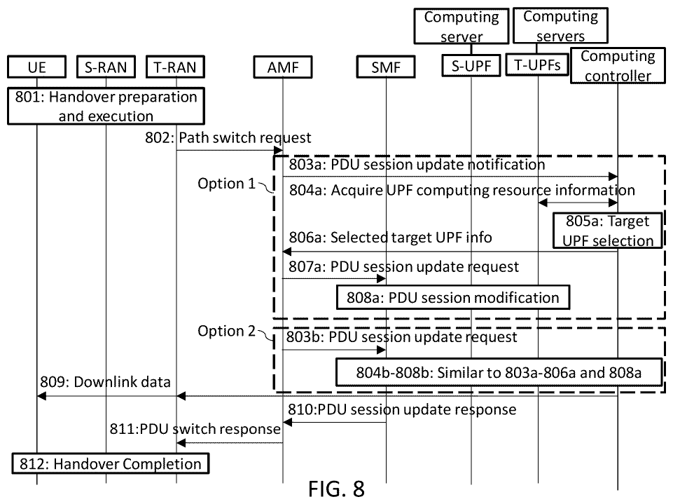

FIG. 8 shows a schematic diagram of a procedure according to an embodiment of the present disclosure. In this embodiment, the computing controller chooses a suitable target UPF for the handover operation. Note that, in FIG. 8, the term “S-UPF” refers to source UPF, the term “T-UPF” refers to target UPF, the term “S-RAN” refers to source RAN and the term “T-RAN” refers to target RAN.

Step 801: The UE moves from the area of the source RAN to the area served by the target RAN. The UE interacts with the source RAN for the handover preparation and execution. The source RAN performs the handover operation and hand over the UE to the target RAN.

Step 802: The target RAN sends a path switch request to the AMF in the core network, wherein the path switch request carries with the location of the UE and other information needed for the handover operation.

### Option 1: AMF as Local Computing Controller

Step 803a: The AMF sends a PDU session update notification to the computing controller, to notify that the UE moves and the PDU session may need an update from the source UPF to a target UPF and to request the information of the target UPF. Note that the target UPF needs to meet the computing power requirement of the UE. The message carries with the location of the UE, the computing power resources required by the UE, . . . , etc.

Step 804a: The computing controller acquires information of the computing power resources of target computing servers from one or more target UPFs serving the area where the UE is located. In an embodiment, each target UPF can get the information of computing power resources of target computing servers from associated served computing servers (e.g., computing server 1 to computing server n).

Step 805a: The computing controller selects a suitable target UPF from the target UPFs having available computing power resources satisfying/meeting the computing power resource requirement of the UE.

Step 806a: The computing controller informs the AMF the information of selected target UPF.

Step 807a: The AMF sends, to the SMF, the PDU session update request carrying with the information of the selected target UPF.

Step 808a: The operation of PDU session modification is performed and completed by interactions between the SMF, the source UPF and the target UPF. The data link is switched from the source UPF to the target UPF.

### Option2: SMF as Local Computing Controller

Step 803b: The AMF send PDU session update request to the SMF.

Steps 804b to 808b: The SMF acquires the information computing power resources from all of the target UPFs and selects a suitable target UPF for the PDU session update operation. The operation of PDU session modification is performed and completed by interactions between the SMF, the source UPF and the target UPF. The data link has switched from the source UPF to the target UPF.

In an embodiment, the steps 804b to 808b are similar to steps 803a to 806a and 808a.

Step 809: After the PDU session is updated, the downlink data can be delivered from the target UPF to the UE via the target RAN.

Step 810: The PDU session is updated successfully and the SMF returns the PDU session update response to the AMF.

Step 811: The AMF sends the path switch response to the target RAN.

Step 812: The handover from source UPF to the target UPF is completed.

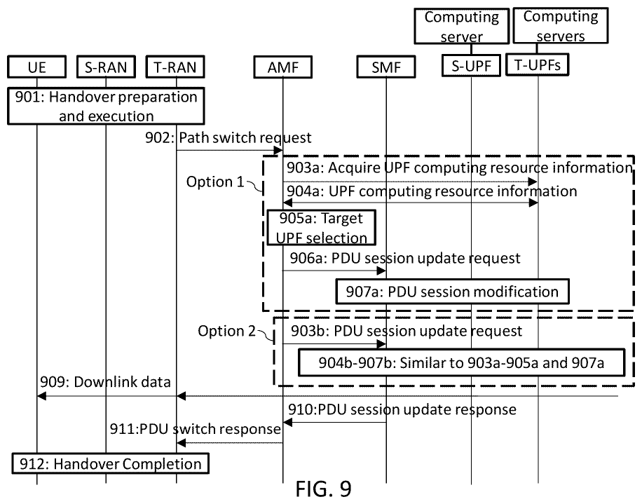

FIG. 9 shows a schematic diagram of a procedure according to an embodiment of the present disclosure. In FIG. 9, the AMF or the SMF chooses a suitable target UPF for the handover operation. Note that the term “S-UPF” refers to source UPF, the term “T-UPF” refers to target UPF, the term “S-RAN” refers to source RAN and the term “T-RAN” refers to target RAN.

Step 901: The UE moves from the area of source RAN to the area of target RAN. The UE interacts with the source RAN for handover preparation and execution. The source RAN performs the handover operation and hand over the UE to the target RAN.

Step 902: The target RAN sends, to the AMF located in the core network, the path switch request carrying with the location of the UE and other information needed for this handover operation.

### Option1: AMF as Local Computing Controller

Step 903a: The AMF acquires information of the computing power resources of target computing servers from all target UPFs serving the area where the UE is located.

Step 904a: Each target UPF acquires the information of computing power resources from associated served computing servers and sends the acquired information to the AMF. In an embodiment, the target UPF acquires the information of computing power resources from associated computing servers (e.g., computing server 1 to computing server n).

Step 905a: The AMF selects a suitable target UPF from those target UPFs having available computing power resources meeting the requirement of the UE.

Step 906a: The AMF sends, to the SMF, the PDU session update request carrying with the information of the selected target UPF.

Step 907a: The operation of PDU session modification is performed and completed by interactions between the SMF, the source UPF and the target UPF. The data link is switched from the source UPF to the target UPF.

### Option2: SMF as Local Computing Controller

Step 903b: The AMF send PDU session update request to the SMF.

Steps 904b to 907b: The SMF acquires the information of the computing power resources from all the target UPFs and selects a suitable target UPF for the PDU session update operation. The operation of PDU session modification is performed and completed by interactions between the SMF, the source UPF and the target UPF. The data link is switched from the source UPF to the target UPF. In an embodiment, steps 904b to 907b are similar to steps 903a to 905a and 907a.

Step 908: After the PDU session is updated, the downlink data can be delivered from the target UPF to the UE via target RAN.

Step 909: The PDU session is updated successfully and the SMF returns the PDU session update response to the AMF.

Step 910: The AMF sends the path switch response to the target RAN.

Step 911: The handover from the source UPF to the target UPF is completed.

In some embodiments, the computing server may be mobile. When the source computing server serving the UE (e.g. providing computing resources for the UE) moves to an area where the source computing server has troubles/issues on serving the UE, the handover from the source computing server to the target computing server is needed to provide the computing power resources to the UE.

That is, in the case of the mobile computing server, the handover from the source computing server to the target computing server may be required.

In some embodiments, when the computing server moves, the computing server reports its location and the information of computing power resources to the computing controller. If the computing controller judges that the source computing server is hard to serve RAN/AMF without performance reducing, the computing controller informs the RAN/AMF to handover the target computing server, carrying with the information of target computing server and RAN/AMF updates the serving computing server with the target computing server.

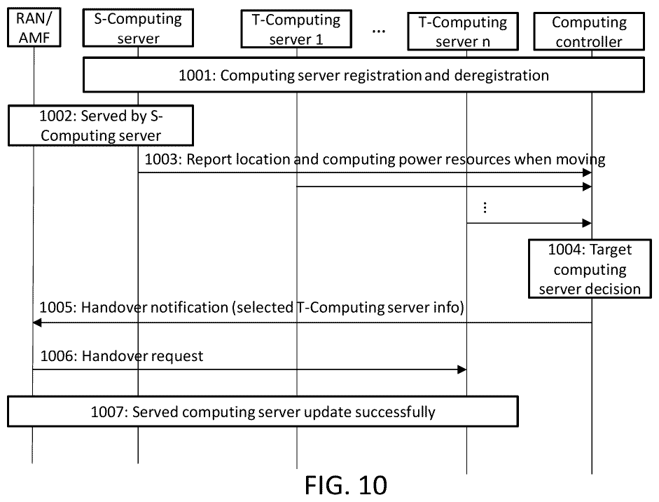

FIG. 10 shows a schematic diagram of a procedure according to an embodiment of the present disclosure. In this embodiment, the computing controller informs the RAN/AMF to initiate a handover from the source computing server to the target computing server when the source computing server moves. In FIG. 10, the term “S-Computing server” refers to source computing server and the term “T-Computing server” refers to target computing server.

Step 1001: Each computing server registers into the computing controller, wherein the registration information may comprise at least one of ID, location, the information of computing power resources of the registered computing server. In an embodiment, the computing server may also deregister from the computing controller if it is out of service.

Step 1002: The RAN/AMF applies for the computing power resources for services and applications to the computing controller and the computing controller allocates the source computing server to offer the computing power resources to the RAN/AMF.

Step 1003: When the source computing server or target computing servers moves, the source computing server or target computing servers should report to the computing controller the location and the information of the computing power resources. In an embodiment, the information of the computing power resources comprises information of the used computing resources and/or the remaining computing resources.

Step 1004: After receiving the information of the location and the information of the computing power resources from the source computing server, The computing controller judges/determines that the source computing server is hard to serve the RAN/UPF without performance downgrading based on the changed location and decides to replace the source computing server with a suitable target computing server. The computing controller selects a target computing server to serve the RAN/AMF.

Step 1005: The computing controller sends a handover notification to the RAN/AMF to inform that the source computing server need to be replaced by the target computing server, wherein the handover notification may carry with the information of the selected target computing server.

Step 1006: The RAN/AMF sends a handover request to the target computing server to update the computing server serving the RAN/AMF.

Step 1007: The operation of handover is successful, and the computing server for the RAN/AMF is updated from the source computing server to the target computing server.

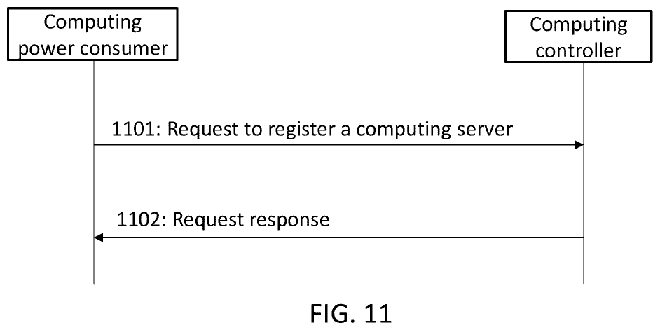

FIG. 11 shows a schematic diagram of a procedure according to an embodiment of the present disclosure. In FIG. 11, the computing power consumer (e.g., computing server) registers into the computing controller.

Step 1101: The computing power consumer registers into the computing controller when offering the service of the computing power resources.

In an embodiment, the registration information comprises at least one of ID (identity), location, the information of computing power resources of the computing power consumer. Note that the registration information may further comprise other information if needed.

Step 1102: The computing controller registers services associated with an existing computing server Instance.

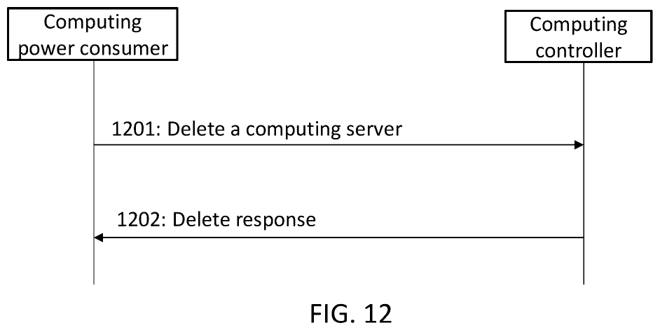

FIG. 12 shows a schematic diagram of a procedure according to an embodiment of the present disclosure. In FIG. 12, the computing power consumer (e.g., computing server) deregisters from the computing controller.

Step 1201: If the computing power consumer (e.g., computing server) is out of service (e.g., because of the mobility or breakdown), the computing controller performs a deregistration/deletion operation when receiving the deleting message from the computing power consumer.

The service operation in step 1201 removes the information of the computing server instance previously registered in the computing controller.

Step 1202: The computing controller responses to the computing power consumer, to indicate that the deregistration/deletion operation is successful or not.

In an embodiment, when the UE or the computing server moves, the source RAN or the source UPF providing the computing sources for the UE may handover to the target RAN or the target UPF which can offer the sufficient computing power resources meeting the requirements of the UE.

In an embodiment, the RAN or UPF acquires the information of computing power resources from computing server serving the RAN or UPF.

In an embodiment, the computing controller decides/selects a suitable RAN or UPF as the target RAN or the target UPF according to the information of the computing power resources offered by the target RAN candidate or target UPF candidate (e.g., the RANs or UPFs serving the area in which the UE locates).

In an embodiment, the source RAN, the AMF or the SMF can decide and/or select the target RAN or target UPF according to the information of the computing power resources.

In an embodiment, the computing controller, source RAN, AMF or SMF can acquire the information of the computing power resources from all target RANs or target UPFs and judge/determine which one is the best candidate to meet the requirements of the UE.

In an embodiment of the computing server being moved, the computing server reports the information of its location and/or its computing power resources.

In an embodiment, the computing controller, RAN, AMF or SMF can transmit information of the selected target RAN, target UPF or target computing server to the source RAN or the AMF.

In an embodiment, an interface between RAN and computing controller is disclosed. The interface may be used/configured to send the handover notification and/or request information of the target RAN.

In an embodiment, an interface between AMF and computing controller is proposed. The interface is configured to send the PDU update notification and/or request information of target RAN.

In an embodiment, the computing controller, source RAN, SMF or AMF is configured to perform at least one of:
collecting the information of computing power resources from all target server or target UPF, or target RAN;
comparing the available computing power resource with the required resources of the UE, to find out which target UPF, computing server, RAN can be used;
selecting a target RAN, or target UPF, or target computing server to the source RAN, or AMF;
sending the information of select target UPF, RAN to the source RAN/AMF; or
sending the handover notification to the RAN/AMF and providing the information of the selected target RAN/computing server/UPF.

In an embodiment, the target RAN or target UPF is configured to perform at least one of:
acquiring the information of computing power resources from computing server(s) serving them; or
sending the information of computing power resources to the computing controller, the source RAN, or the AMF.

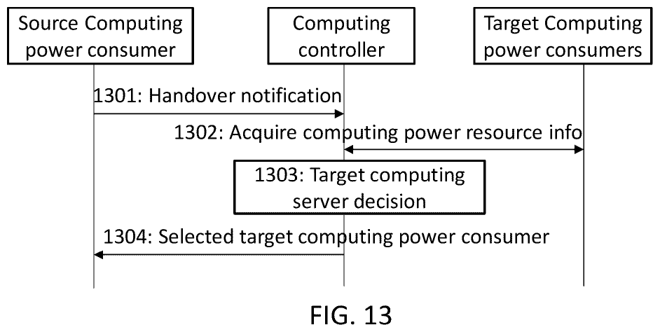

FIG. 13 shows a schematic diagram of a procedure according to an embodiment of the present disclosure. In FIG. 13, the source computing power consumer (e.g., RAN, AMF, or SMF) transmits a handover notification to the computing controller. The handover notification comprises at least one of location information of a wireless device (e.g., UE) or a computing power resource requirement (step 1301). The computing controller acquires information of computing power resources from target computing power consumers (e.g., RANs, UPFs, wireless network nodes with computing resources, or wireless network nodes associated with computing servers) serving an area in which the wireless device locates is located and determines/selects one of the target computing power consumers based on the acquired information and the computing power resource requirement. Note that the computing controller may acquire location information from all of target computing power consumers and determines whether each target computing power consumers serves the area in which the wireless device locates (steps 1302 and 1303). The computing controller then transmits information of the selected target computing power consumer to the source computing power consumer (step 1304). The source computing power consumer may perform the follow-up handover procedure to hand over the computing power consumer serving the wireless device from the source computing power consumer to the selected target computing power consumer. That is, after the follow-up handover procedure, the computing power consumer serving the wireless device changes from the source computing power consumer to the selected target computing power consumer.

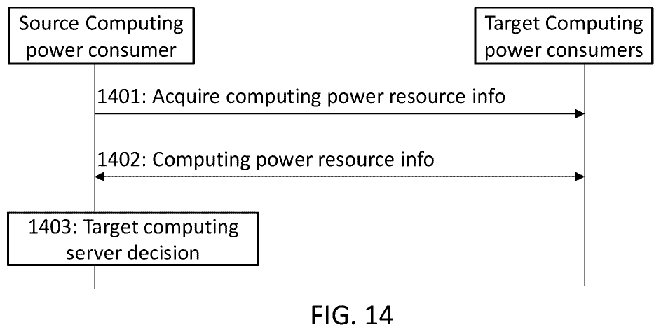

FIG. 14 shows a schematic diagram of a procedure according to an embodiment of the present disclosure. In FIG. 14, the source computing power consumer (e.g., RAN, AMF or SMF) may receive a handover request from a wireless device or determine that a wireless device needs to be handed over. For example, the wireless device may move outside of the serving area of the source computing power consumer, the communication performance between the wireless device and the source computing power consumer is downgraded or the wireless device requires more computing power (resources) than the computing power consumer can provide. Under such conditions, the source computing power consumer acquires computing power resource information from each target computing power consumers (e.g., RAN, UPF, wireless network nodes with computing resources, or wireless network nodes associated with computing servers) serving an area in which the wireless device locates (steps 1401 and 1402). The source computing power consumer determines/selects one of the target computing power consumers based on the acquired information and the computing power resource requirement of the wireless device (step 1403). The source computing power consumer may perform the follow-up handover procedure to hand over the computing power consumer serving the wireless device from the source computing power consumer to the selected target computing power consumer. That is, after the follow-up handover procedure, the computing power consumer serving the wireless device changes from the source computing power consumer to the selected target computing power consumer. That is, in FIG. 14, the source computing power consumer acts as a local computing controller.

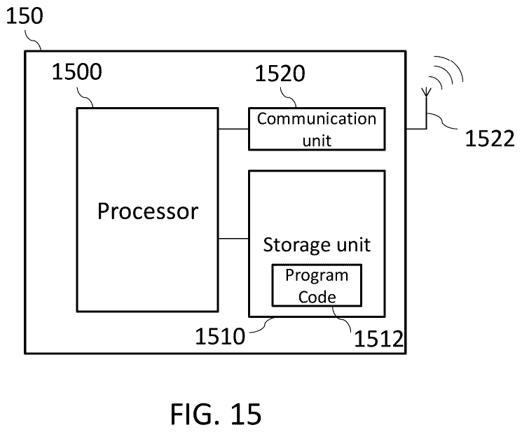

FIG. 15 relates to a schematic diagram of a wireless terminal 150 according to an embodiment of the present disclosure. The wireless terminal 150 may be a user equipment (UE), a mobile phone, a laptop, a tablet computer, an electronic book or a portable computer system and is not limited herein. The wireless terminal 150 may include a processor 1500 such as a microprocessor or Application Specific Integrated Circuit (ASIC), a storage unit 1510 and a communication unit 1520. The storage unit 1510 may be any data storage device that stores a program code 1512, which is accessed and executed by the processor 1500. Embodiments of the storage unit 1510 include but are not limited to a subscriber identity module (SIM), read-only memory (ROM), flash memory, random-access memory (RAM), hard-disk, and optical data storage device. The communication unit 1520 may a transceiver and is used to transmit and receive signals (e.g., messages or packets) according to processing results of the processor 1500. In an embodiment, the communication unit 1520 transmits and receives the signals via at least one antenna 1522 shown in FIG. 15.

In an embodiment, the storage unit 1510 and the program code 1512 may be omitted and the processor 1500 may include a storage unit with stored program code.

The processor 1500 may implement any one of the steps in exemplified embodiments on the wireless terminal 150, e.g., by executing the program code 1512.

The communication unit 1520 may be a transceiver. The communication unit 1520 may as an alternative or in addition be combining a transmitting unit and a receiving unit configured to transmit and to receive, respectively, signals to and from a wireless network node (e.g., a base station).

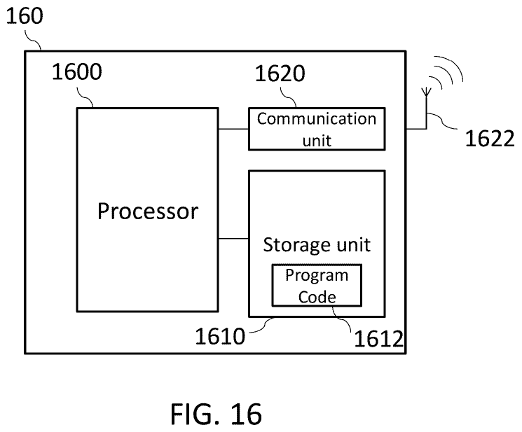

FIG. 16 relates to a schematic diagram of a wireless network node 160 according to an embodiment of the present disclosure. The wireless network node 160 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 160 may comprise (perform) at least one network function such as an access and mobility management function (AMF), a session management function (SMF), a user place function (UPF), a policy control function (PCF), an application function (AF), etc. The wireless network node 160 may include a processor 1600 such as a microprocessor or ASIC, a storage unit 1610 and a communication unit 1620. The storage unit 1610 may be any data storage device that stores a program code 1612, which is accessed and executed by the processor 1600. Examples of the storage unit 1610 include but are not limited to a SIM, ROM, flash memory, RAM, hard-disk, and optical data storage device. The communication unit 1620 may be a transceiver and is used to transmit and receive signals (e.g., messages or packets) according to processing results of the processor 1600. In an example, the communication unit 1620 transmits and receives the signals via at least one antenna 1622 shown in FIG. 16.

In an embodiment, the storage unit 1610 and the program code 1612 may be omitted. The processor 1600 may include a storage unit with stored program code.

The processor 1600 may implement any steps described in exemplified embodiments on the wireless network node 160, e.g., via executing the program code 1612.

The communication unit 1620 may be a transceiver. The communication unit 1620 may as an alternative or in addition be combining a transmitting unit and a receiving unit configured to transmit and to receive, respectively, signals to and from a wireless terminal (e.g., a user equipment or another wireless network node).

In the present disclosure, the wireless network node, the wireless device or the wireless termina comprises a network function (e.g., AMF, SMF, or UPF) and/or a network element refers to a device performing at least part of functionalities of the network function(s) and/or network element comprised in the device.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a computing power controlling node, the wireless communication method comprising:
acquiring computing power resource information of at least one computing power consuming node, and
selecting a target computing power consuming node from the at least one target computing power consuming node candidate based on the computing power resource information of the at least one target computing power consuming node candidate and computing power requirement information of a wireless device, for a handover associated with computing power resources for the wireless device.

2. The wireless communication method of claim 1, wherein the at least one target computing power consuming node candidate serves an area in which the wireless device locates.

3. The wireless communication method of claim 1, further comprising:
transmitting, to a wireless network node serving the wireless device, information of the target computing power consuming node.

4. The wireless communication method of claim 1, further comprising:
receiving, from the wireless network node, a handover notification of the handover.

5. The wireless communication method of claim 4, wherein the handover notification comprises at least one of the computing power requirement information or location information of the wireless device.

6. The wireless communication method of claim 3, wherein the wireless network node comprises at least one of a base station, an access and mobility management function or a session management function.

7. The wireless communication method of claim 1, further comprising:
handing over a computing power consuming node serving the wireless device from a source computing power consuming node to the target computing power consuming node.

8. The wireless communication method of claim 7, further comprising:
determining the handover of the wireless device, or
receiving a handover request associated with the handover of the wireless device.

9. The wireless communication method of claim 7, wherein the computing power controlling node comprises at least one of a base station serving the wireless device, an access and mobility management function serving the wireless device or a session management function serving the wireless terminal.

10. The wireless communication method of claim 1, wherein the computing power consuming node comprises at least one of a base station, a user plane function, or a computing power node which has computing power resources or is associated with at least one computing power server.

11. A wireless communication method for use in a wireless network node, the wireless communication method comprising:
transmitting, to a computing power controlling node, a handover notification of a handover associated with computing power resources for a wireless device, and
receiving, from the computing power controlling node, a target computing power consuming node for the handover.

12. The wireless communication method of claim 11, further comprising:
handing over a computing power consuming node serving the wireless device from a source computing power consuming node to the target computing power consuming node.

13. The wireless communication method of claim 11, wherein the handover notification comprises at least one of computing power requirement information or location information of the wireless device.

14. The wireless communication method of claim 11, wherein the wireless network node comprises at least one of a base station, an access and mobility management function or a session management function serving the wireless device.

15. The wireless communication method of claim 11, wherein the target computing power consuming node comprises at least one of a base station, a user plane function or a computing power node which has computing power resources or is associated with at least one computing power server.

16. A computing power controlling node, comprising:
at least one processor, configured to:
acquire computing power resource information of at least one computing power consuming node, and
select a target computing power consuming node from the at least one target computing power consuming node candidate based on the computing power resource information of the at least one target computing power consuming node candidate and computing power requirement information of a wireless device, for a handover associated with computing power resources for the wireless device.

17. A wireless network node, comprising:
a communication unit configured to perform the wireless communication method of claim 11.
